(19) United States
(12) Patent Application Publication
(10) Pub. No.: US 2014/0196996 A1
(43) Pub. Date: Jul. 17, 2014

(54) BOOM SPRAYER AND BOOM VIBRATION CONTROL DEVICE

(71) Applicant: KAYABA INDUSTRY CO., LTD., Tokyo (JP)

(72) Inventors: Tatsuo ITO, Sagamihara-shi (JP); Takanori INADA, Sagamihara-shi (JP); Takanobu YOSHIDA, Saitama-shi (JP); Tomomichi MIZUKAMI, Tokorozawa-shi (JP); Atsushi OOTA, Morioka-shi (JP); Daiki SHIBASAKI, Iruma-shi (JP); Masaki AKASHI, Inzai-shi (JP); Yasuo TANAKA, Toda-shi (JP)

(73) Assignee: KAYABA INDUSTRY CO., LTD., Tokyo (JP)

(21) Appl. No.: 14/152,967

(22) Filed: Jan. 10, 2014

(30) Foreign Application Priority Data
Jan. 11, 2013 (JP) 2013-3993

(51) Int. Cl. F16F 15/023; A01B 63/10; F16F 15/027; B05B 1/20; A01M 7/00

(52) U.S. Cl. CPC F16F 15/023; B05B 1/20; A01M 7/0057; F16F 15/027; A01B 63/1006
USPC 188/266.2; 188/314

(57) ABSTRACT

A boom vibration control device that is configured to suppress vibration of a boom that is cantilever-supported on a working vehicle includes a left-roll-direction biasing unit that biases the boom in the left roll direction with respective to the working vehicle and right-roll-direction biasing unit that biases the boom in the right roll direction with respective to the working vehicle. The boom is held at the roll angle at which the biasing force of the left-roll-direction biasing unit and the biasing force of the right-roll-direction biasing unit are balanced.

### TECHNICAL FIELD

The present invention relates to a boom sprayer and a boom vibration control device.

### BACKGROUND ART

JP2004-254526A discloses a boom sprayer. This boom sprayer includes a boom support frame that is raised and lowered by a raising and lowering linkage mechanism provided on a front side of a working vehicle, a rocking shaft that is provided on the boom support frame and extends in the front-to-rear direction, left and right booms that are cantilever-supported on the rocking shaft in a rollable manner, a hydraulic cylinder that is interposed between the boom support frame and the boom, a tilt detector that detects the tilt angle of the working vehicle, a rocking-angle detector that detects the boom-rocking angle against the boom support frame, and a control device that controls the extension and contraction of the hydraulic cylinder.

When the boom sprayer is operated, in the case where the working vehicle is tilted in a roll direction, the booms supported on the raising and lowering linkage mechanism also tend to tilt in the same direction. The control device controls the extension and contraction of the hydraulic cylinder in accordance with the detected signals from the tilt detector and the rocking-angle detector such that the tilt angles of the left and right booms become set values. By doing so, the booms are maintained at the horizontal posture or at a set angled posture.

### SUMMARY OF INVENTION

In the case where the working vehicle runs over a rough surface in a field, such as ridges, the working vehicle may periodically repeat the rolling movement in the roll direction, which is a roll about the front-to-rear axis. In this case, the hydraulic cylinder whose extension and contraction is controlled by the control device cannot absorb the high-frequency vibration input to the booms from the vehicle body of the working vehicle, and there is a possibility that the booms periodically repeat rolling movement in the roll direction is caused.

The object of the present invention is to provide a boom sprayer and a boom vibration control device that are capable of suppressing vibration of a boom in the roll direction.

According to one aspect of the present invention, a boom vibration control device that is configured to suppress vibration of a boom that is cantilever-supported on a working vehicle is provided. The boom vibration control device includes a left-roll-direction biasing unit that biases the boom in a left roll direction with respective to the working vehicle and a right-roll-direction biasing unit that biases the boom in a right roll direction with respective to the working vehicle. The boom is held at a roll angle at which a biasing force of the left-roll-direction biasing unit and a biasing force of the right-roll-direction biasing unit are balanced.

### BRIEF DESCRIPTION OF DRAWINGS

FIG. 1 is a plan view of a boom sprayer according to a first embodiment of the present invention;

FIG. 2 is a side view of the boom sprayer according to the first embodiment of the present invention;

FIG. 3 is a perspective view of the boom sprayer according to the first embodiment of the present invention;

FIG. 4 is a configuration diagram of a boom vibration control device according to the first embodiment of the present invention;

FIG. 5 is a configuration diagram of a boom vibration control device according to a second embodiment of the present invention;

FIG. 6 is a configuration diagram of a boom vibration control device according to a third embodiment of the present invention; and

FIG. 7 is a configuration diagram of a boom vibration control device according to a fourth embodiment of the present invention.

### DESCRIPTION OF EMBODIMENTS

Embodiments of the present invention and advantages thereof are described in detail below with reference to the accompanying drawings.

For the sake of convenience of explanation, three mutually orthogonal axes, X, Y, and Z, are set on the attached drawings. X-axis extends in the front-to-rear direction (substantially horizontal longitudinal direction) of a vehicle, Y-axis extends in the left-to-right direction (substantially horizontal lateral direction) of the vehicle, and Z-axis extends in the vertical direction (substantially upright direction) of the vehicle. A rotation direction centered at the X-axis is referred to as a roll direction, and a rotation direction centered at the Z-axis is referred to as a yaw direction.

First, the first embodiment will be described.

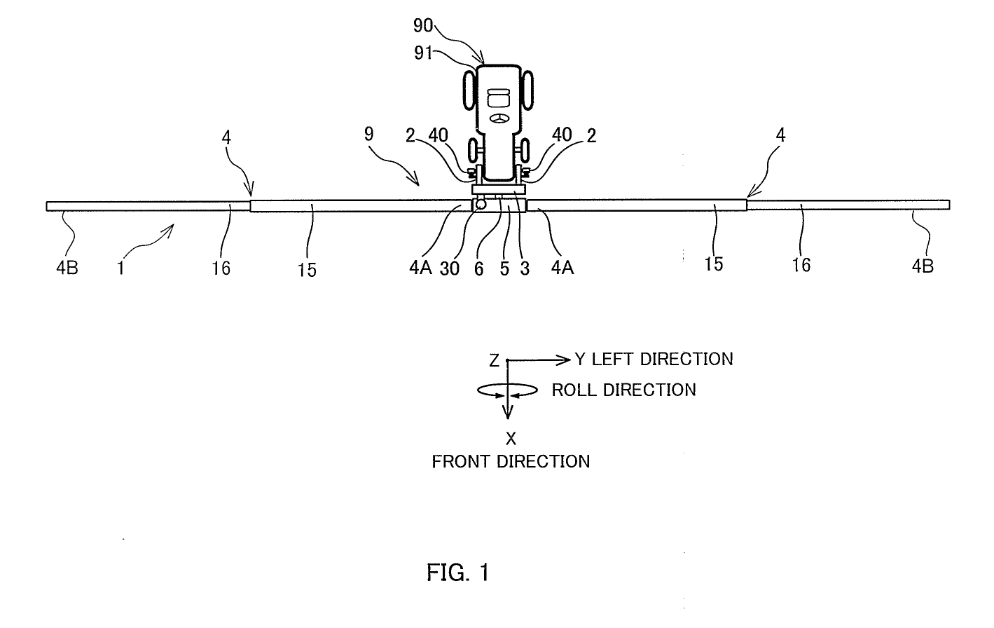

A boom sprayer 1 shown in FIG. 1 is an agricultural working machine that is mounted on the front side of a working vehicle (tractor) 90 that runs in a field and that sprays pest control fluid (agricultural chemicals) from the working vehicle 90.

The boom sprayer 1 includes a pair of booms 4 that extend in the left and right directions from the working vehicle 90. The booms 4 include nozzles (not shown) for spraying pest control fluid. During the operation of the boom sprayer 1, a pest control fluid is sprayed from the nozzles of the booms 4 while the working vehicle 90 is running in a field.

The boom sprayer 1 includes linkage arms 2 that are attached to a vehicle body 91, a raising and lowering mount 3 that is supported on the vehicle body 91 with the linkage arms 2 so as to be able to be raised and lowered, a roll mount 5 that is supported on the raising and lowering mount 3 so as to be rotatable in the roll direction (about the X-axis), and the left and right booms 4 that extend from the roll mount 5 in the left and right directions (the Y-axis direction) of the vehicle body 91.

The roll mount 5 forms a support part for the booms 4, which cantilever-supports each of the left and right booms 4 with respect to the raising and lowering mount 3.

Base-end portions 4A of the booms 4 are cantilever-supported on the roll mount 5 via retractable hinges (not shown) so as to be rotatable in the yaw direction (about the Z-axis). Tip-end portions 4B of the booms 4 are free ends. The booms 4 include base-end side frames 15 having the base-end portions and tip-end side frames 16 having the tip-end portions 4B, and the tip-end side frames 16 are supported on the base-end side frames 15 so as to be extendable and contractable.

In an extended state shown in FIG. 1, the left and right booms 4 extend horizontally in the left and right directions of the working vehicle 90. With this extended state, the length (width) between the tip ends of the left and right booms 4 is, for example, 10 to 20 meters. When the booms 4 are to be retracted, the booms 4 are contracted from the operational position so as to have about halved projected length, and thereafter, the booms 4 are rotated towards the rear direction via the retractable hinges. By doing so, the booms 4 are folded so as to extend in the front-to-rear direction along the side of the vehicle body 91.

The roll mount 5 is supported on the raising and lowering mount 3 so as to be rotatable in the roll direction via a support shaft 6. Although the support shaft 6 is a cylindrical pin, it is not limited thereto, and a spherical bearing etc. may be used.

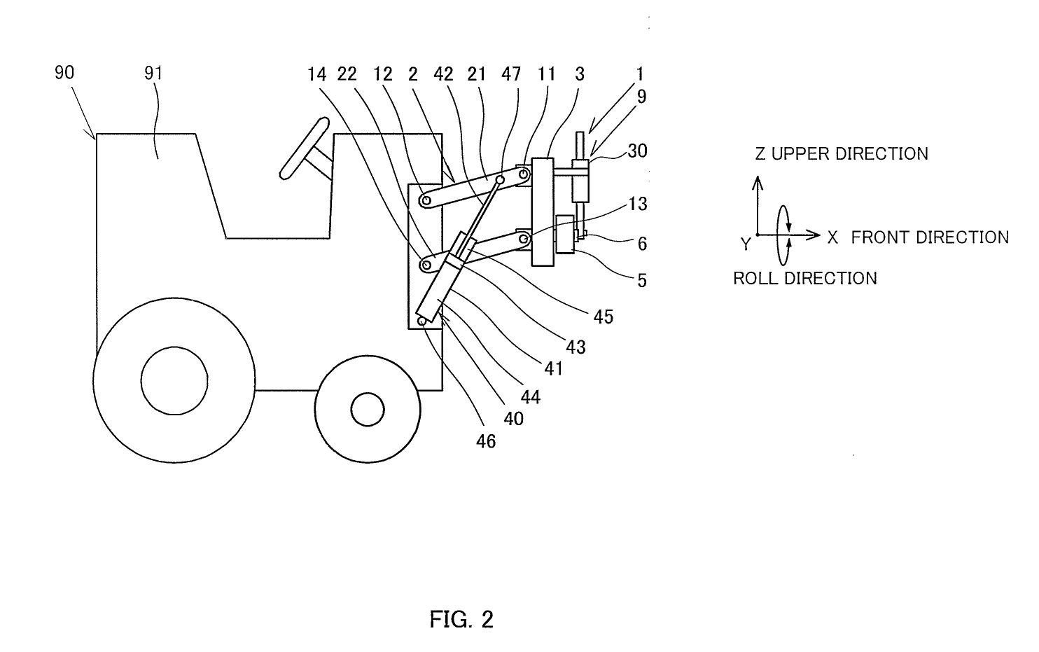

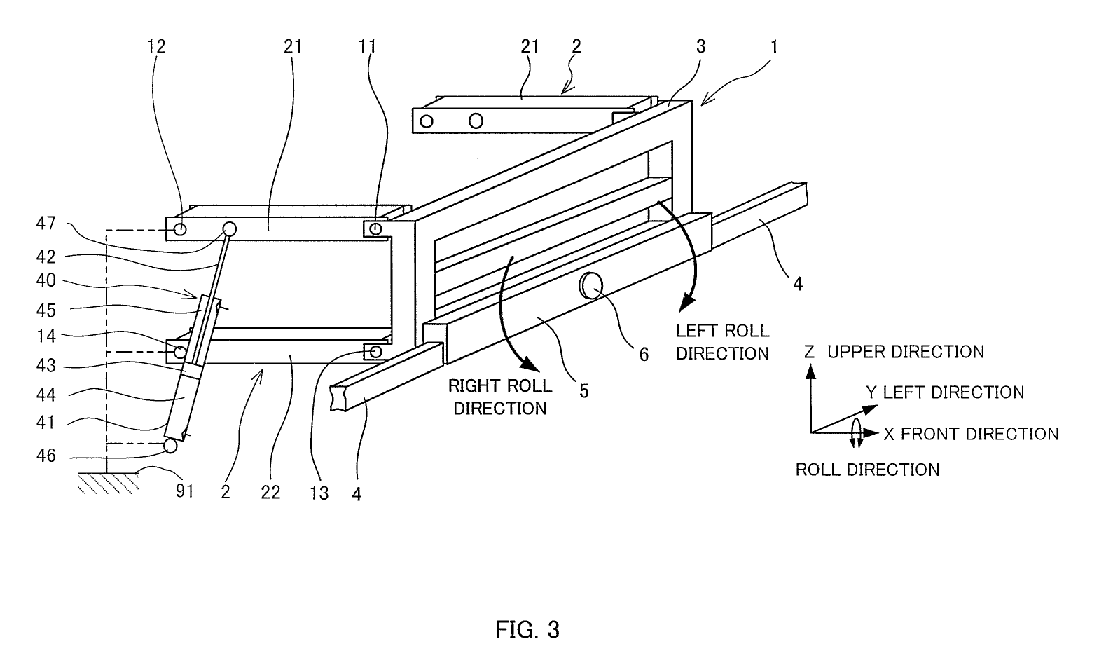

FIG. 2 is a side view schematically showing the configuration of the boom sprayer 1. FIG. 3 is a perspective view showing the vicinity of the raising and lowering mount 3. The boom sprayer 1 includes a pair of linkage arms 2 at both of the left and right side portions of the vehicle body 91. The linkage arms 2 have upper linkages 21 and lower linkages 22 that extend in parallel to each other, and the linkage arms 2 form a linkage mechanism having a parallelogram shape when viewed from the side.

Base-end portions of the upper linkages 21 are rotatably linked to the vehicle body 91 via pins 12, and tip-end portions of the upper linkages 21 are rotatably linked to the raising and lowering mount 3 via pins 11. Base-end portions of the lower linkages 22 are rotatably linked to the vehicle body 91 via pins 14, and tip-end portions of the lower linkages 22 are rotatably linked to the raising and lowering mount 3 via pins 13.

The raising and lowering mount 3 is supported by each of the linkage arms 2 at the front part of the vehicle body 91 so as to be able to be raised and lowered. Instead of this configuration, it is possible to employ a configuration in which a guide rail extending in the Z-axis direction may be provided on the front part of the vehicle body 91, and this guide rail may be used to support the raising and lowering mount 3 so as to be able to be raised and lowered.

A pair of raising and lowering cylinders 40 are provided on both of the left and right sides of the vehicle body 91. Each of the raising and lowering cylinders 40 is an actuator that is interposed between the vehicle body 91 and the upper linkage 21 and that raises and lowers the raising and lowering mount 3 and the booms 4 by being extended and contracted.

The raising and lowering cylinder 40 includes a cylinder tube 41 filled with a hydraulic oil, a piston rod 42 that is slidably inserted into the cylinder tube 41, and a piston 43 that is provided on the base-end portion of the piston rod 42. The base-end portion of the cylinder tube 41 is rotatably linked to the vehicle body 91 via a spherical bearing 46, and the tip-end portion of the piston rod 42 is rotatably linked to the upper linkage 21 via a spherical bearing 47. The spherical bearings 46 and 47 are constituted of, for example, a ball and a spherical bearing. Linkage portions of the raising and lowering cylinders 40 are configured such that occurrence of prying force is prevented by the spherical bearings 46 and 47.

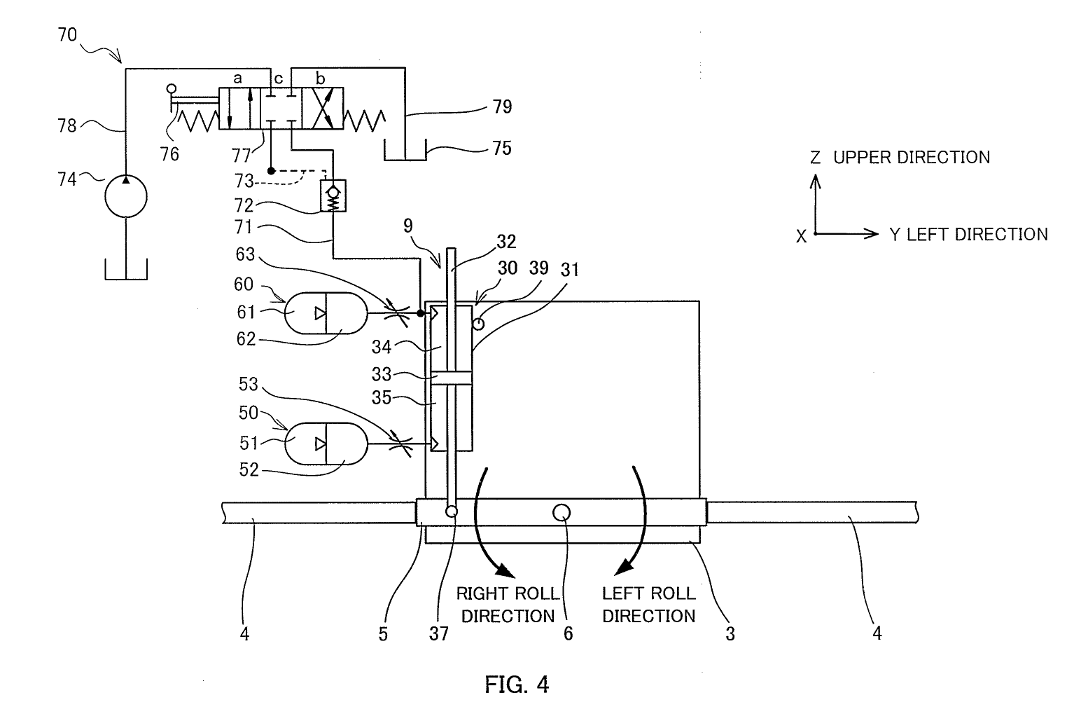

The inside of the cylinder tube 41 is partitioned into a bottom-side chamber 44 and a head-side chamber 45 by the piston 43. The hydraulic oil is supplied/discharged to/from the bottom-side chamber 44 and the head-side chamber 45 by a hydraulic-fluid supply and discharge device 70 (see FIG. 4). The raising and lowering cylinders 40 are extended and contracted in accordance with the supply and discharge of the hydraulic oil. In other words, the raising and lowering cylinders 40 are double-acting fluid pressure cylinders. Instead of using a double-acting fluid pressure cylinder, a single-acting fluid pressure cylinder in which the hydraulic oil is supplied/discharged to/from only one of the bottom-side chamber 44 and the head-side chamber 45 may be used as the raising and lowering cylinder 40.

When the heights of the booms 4 are to be changed, by extending/contracting the left and right raising and lowering cylinders 40 in synchronization, the left and right linkage arms 2 are pivoted to raise/lower the raising and lowering mount 3 and the booms 4 with respective to the vehicle body 91. Specifically, as the raising and lowering cylinders 40 are extended, the linkage arms 2 are pivoted upward, and the raising and lowering mount 3 and the booms 4 are raised. On the other hand, as the raising and lowering cylinders 40 are contracted, the linkage arms 2 are pivoted downward, and the raising and lowering mount 3 and the booms 4 are lowered. By extending/contracting the raising and lowering cylinders 40, the boom sprayer 1 can adjust the heights of the booms 4 from a crop plant in a field.

A boom vibration control device 9 is provided between the raising and lowering mount 3 and the booms 4. The boom vibration control device 9 suppresses the vibration of the booms 4 in the roll direction, thereby suppressing the vibration of the tip-end portions 4B of the booms 4 in the vertical direction.

In the following description, as indicated by arrows in FIGS. 3 and 4, when the working vehicle 90 is viewed from the front, the leftward rotation direction about the X-axis is referred to as the right roll direction (positive roll direction), and the rightward rotation direction is referred to as the left roll direction (negative roll direction).

FIG. 4 is a schematic configuration diagram of the boom vibration control device 9. The boom vibration control device 9 includes a fluid pressure cylinder 30 that is extended and contracted in an interlocked manner with the roll of the booms 4 in the left and right roll directions.

The fluid pressure cylinder 30 includes a cylinder tube 31 filled with the hydraulic oil and a piston rod 32 that is slidably inserted into the cylinder tube 31.

Although the hydraulic oil is used as the hydraulic fluid in the fluid pressure cylinder 30, a working fluid, such as, for example, an alternative aqueous fluid etc., or gas may be used instead of the hydraulic oil.

The cylinder tube 31 is rotatably linked to the raising and lowering mount 3 via a spherical bearing 39. The tip-end portion of the piston rod 32 is rotatably linked to the roll mount 5 via a spherical bearing 37. In other words, the cylinder tube 31 is linked to the working vehicle 90 via the raising and lowering mount 3 and the piston rod 32 is linked to the booms 4 via the roll mount 5. With such a configuration, if the booms 4 are rolled in the roll direction, the fluid pressure cylinder 30 is extended and contracted.

Instead of the above-mentioned configuration, the piston rod 32 may be linked to the working vehicle 90 via the raising and lowering mount 3 and the cylinder tube 31 may be linked to the booms 4 via the roll mount 5.

A piston 33 is provided at the intermediate portion of the piston rod 32. The inside of the cylinder tube 31 is partitioned into a head-side chamber 35 and a bottom-side chamber 34 by the piston 33.

A first accumulator 50 is connected to the head-side chamber 35. The hydraulic oil in the head-side chamber 35 flows into and out of the first accumulator 50 with the roll of the booms 4 in the roll direction. The first accumulator 50 includes an oil chamber 52 that is in communication with the head-side chamber 35 and a first accumulator portion 51 that stores the compressed gas for pressurizing the oil chamber 52. The first accumulator portion 51 constitutes a left-roll-direction biasing unit that pressurizes the head-side chamber 35 to bias the booms 4 in the left roll direction.

A second accumulator 60 is connected to the bottom-side chamber 34. The hydraulic oil in the bottom-side chamber 34 flows into and out of the second accumulator 60 with the roll of the booms 4 in the roll direction. The second accumulator 60 includes an oil chamber 62 that is in communication with the bottom-side chamber 34 and a second accumulator portion 61 that stores the compressed gas for pressurizing the oil chamber 62. The second accumulator portion 61 constitutes a right-roll-direction biasing unit that pressurizes the bottom-side chamber 34 to bias the booms 4 in the right roll direction.

When the fluid pressure cylinder 30 is contracted by the roll of the booms 4 in the left roll direction, while the hydraulic oil in the contracting bottom-side chamber 34 flows into the second accumulator 60, the hydraulic oil in the first accumulator 50 flows into the extending head-side chamber 35. Conversely, when the fluid pressure cylinder 30 is extended by the roll of the booms 4 in the right roll direction, while the hydraulic oil in the second accumulator 60 flows into the extending bottom-side chamber 34, the hydraulic oil in the contracting head-side chamber 35 flows into the first accumulator 50.

As described above, because the same amount of hydraulic oil is supplied/discharged to/from the first accumulator 50 and the second accumulator 60 with the roll of the booms 4 in the left and right roll directions, a gas pressure difference is generated between the first accumulator 50 and the second accumulator 60. The booms 4 are held at the position where the biasing force biasing the booms 4 in the left roll direction by the gas pressure of the first accumulator 50 and the biasing force biasing the booms 4 in the right roll direction by the gas pressure of the second accumulator 60 are balanced.

The fluid pressure cylinder 30 is a double-rod cylinder that has the piston rod 32 protruding from both end sides of the cylinder tube 31. With such a configuration, when the fluid pressure cylinder 30 is extended and contracted, the amount of hydraulic oil moving between the bottom-side chamber 34 and the second accumulator 60 and the amount of hydraulic oil moving between the head-side chamber 35 and the first accumulator 50 are equalized, and the amount of change in the varying gas pressure of the first accumulator 50 and the amount of change in the varying gas pressure of the second accumulator 60 are equalized to each other.

The configuration is not limited to that mentioned above, and it is possible to employ a configuration in which a head-side gas chamber and a bottom-side gas chamber that are filled with the compressed gas are each defined via respective free pistons in the cylinder tube 31, and the piston 33 is biased to a neutral position by the gas pressure in the gas chambers.

A damping valve 53, serving as a throttle, is interposed at a channel communicating the oil chamber 52 of the first accumulator 50 and the head-side chamber 35. The damping valve 53 provides resistance on the flow of the hydraulic oil flowing between the head-side chamber 35 and the oil chamber 52 with the extension and contraction of the fluid pressure cylinder 30. By doing so, a damping force suppressing the vibration of the booms 4 in the roll direction is generated.

A damping valve 63, serving as a throttle, is interposed at a channel communicating the oil chamber 62 of the second accumulator 60 and the bottom-side chamber 34. Because the damping valve 63 provides resistance on the flow of the hydraulic oil flowing between the bottom-side chamber 34 and the oil chamber 62 with the extension and contraction of the fluid pressure cylinder 30, a damping force suppressing the vibration of the booms 4 in the roll direction is generated.

As described above, the damping valves 53 and 63 provide resistance on the hydraulic oil flowing into and out of the fluid pressure cylinder 30 and perform the damping function that suppresses the vibration of the booms 4 in the roll direction. The damping valves 53 and 63 are variable throttles in which the opening area increases as the flow rate of the passing hydraulic oil increases. In the channel communicating the oil chamber 52 of the first accumulator 50 and the head-side chamber 35 and the channel communicating the oil chamber 62 of the second accumulator 60 and the bottom-side chamber 34, it is possible to employ a configuration in which fixed throttles, such as orifices etc., are interposed instead of the damping valves 53 and 63, and an area of the throttle flow channel and a length of the throttle flow channel length may be manually adjustable.

The boom sprayer 1 includes the hydraulic-fluid supply and discharge device 70 that supplies/discharges the hydraulic oil to/from the fluid pressure cylinder 30. The hydraulic-fluid supply and discharge device 70 adjusts the set roll angle of the booms 4 by supplying/discharging the hydraulic oil to/from the fluid pressure cylinder 30 to extend and contract the fluid pressure cylinder 30.

The hydraulic-fluid supply and discharge device 70 includes a supply and discharge channel 71 that is in communication with the bottom-side chamber 34 of the fluid pressure cylinder 30, a pilot operated check valve 72 that is interposed at the supply and discharge channel 71, and a direction selector valve 77 that switches the communication of the supply and discharge channel 71 between a hydraulic pump 74 (a fluid pressure source) and a tank 75.

The direction selector valve 77 is connected to a supply channel 78 that guides the hydraulic oil discharged from the hydraulic pump 74, a discharge channel 79 that returns the hydraulic oil to the tank 75, an operation channel 73 that is in communication with a pilot pressure chamber of the pilot operated check valve 72, and the supply and discharge channel 71 that is in communication with the bottom-side chamber 34.

The direction selector valve 77 has a left roll position a, a right roll position b, and a neutral position c, and a driver can change these positions by operating a lever 76.

By switching the direction selector valve 77 to the left roll position a, the supply channel 78 is allowed to be in communication with the operation channel 73 and the supply and discharge channel 71 is allowed to be in communication with the discharge channel 79. A pump pressure of the hydraulic pump 74 is guided to the pilot operated check valve 72 as a pilot pressure through the operation channel 73 to open the pilot operated check valve 72. Furthermore, the hydraulic oil in the bottom-side chamber 34 is discharged to the tank 75 through the supply and discharge channel 71 and the discharge channel 79. By doing so, the piston 33 of the fluid pressure cylinder 30 moves upward to roll the booms 4 in the left roll direction.

By switching the direction selector valve 77 to the right roll position b, the discharge channel 79 is allowed to be in communication with the operation channel 73 and the supply and discharge channel 71 is allowed to be in communication with the supply channel 78. The hydraulic oil pumped from the hydraulic pump 74 flows into the bottom-side chamber 34 through the supply channel 78 and the supply and discharge channel 71. By doing so, the piston 33 of the fluid pressure cylinder 30 moves downward to roll the booms 4 in the right roll direction.

If the direction selector valve 77 is switched to the neutral position c, the supply channel 78, the discharge channel 79, the operation channel 73, and the supply and discharge channel 71 are respectively closed. By doing so, the hydraulic oil is prevented from flowing in and out of the bottom-side chamber 34, and the pilot operated check valve 72 is closed, and therefore, the movement of the piston 33 in the fluid pressure cylinder 30 is stopped, thus to stopping the roll of the booms 4.

As described above, as a driver operates the direction selector valve 77 to cause the booms 4 roll in the left and right roll directions and to make them stop, the roll angle of the booms 4 is adjusted. The hydraulic-fluid supply and discharge device 70 constitutes a roll-angle adjusting mechanism that adjusts the roll angle of the booms 4 by rolling the booms 4 in the roll direction.

The configuration of the hydraulic-fluid supply and discharge device 70 is not limited to that in which the booms 4 are rolled in the roll direction by supplying/discharging the hydraulic oil to/from the bottom-side chamber 34 of the fluid pressure cylinder 30, and it is possible to employ a configuration in which the booms 4 are rolled in the roll direction by supplying/discharging the hydraulic oil to/from the head-side chamber 35.

In addition, the hydraulic-fluid supply and discharge device 70 may have the configuration in which the booms 4 are rolled in the roll direction by supplying/discharging the hydraulic oil to/from the bottom-side chamber 34 of the fluid pressure cylinder 30 and also by supplying/discharging the hydraulic oil to/from the head-side chamber 35. In this case, it is preferred to perform the control such that the amount of hydraulic oil supplied/discharged to/from the bottom-side chamber 34 is equalized to the amount of hydraulic oil supplied/discharged to/from the head-side chamber 35.

When the boom sprayer 1 is operated, a pest control fluid is sprayed from nozzles of the booms 4 while the working vehicle 90 is running in a field. At this time, the left and right booms 4 are centered to the position (the roll angle) where the gas pressure of the first accumulator portion 51 and that of the second accumulator portion 61 are balanced in accordance with strokes of the fluid pressure cylinder 30.

In the case where, for example, the working vehicle 90 runs over a rough surface in a field and the posture of the working vehicle 90 is changed in the roll direction when the boom sprayer 1 is operated, the force that causes the booms 4 to roll in the roll direction acts on the roll mount 5 via the fluid pressure cylinder 30. Because the booms 4 tend to stay at the same position due to the inertial force, the fluid pressure cylinder 30 extends and contracts to absorb the tilt of the working vehicle 90. Although the rolling vibration of the booms 4 begins if the fluid pressure cylinder 30 cannot absorb the tilt of the working vehicle 90 completely and the force by the gas pressure difference between the first accumulator portion 51 and the second accumulator portion 61 exceeds the inertial force of the booms 4, the rolling vibration is damped rapidly by the damping valves 53 and 63.

As described above, because the change in the force acting on the roll mount 5 from the working vehicle 90 is moderated by the extension and contraction of the fluid pressure cylinder 30, it is possible to suppress the excessively large roll of the booms 4 in the roll direction and to prevent the tip-end portions 4B of the booms 4 from hitting a field etc. Furthermore, because the damping valves 53 and 63 provide resistance on the flow of the hydraulic oil flowing in and out of the first accumulator 50 and the second accumulator 60 with the extension and contraction of the fluid pressure cylinder 30, it is possible to suppress the vibration of the booms 4 in the roll direction. By doing so, it is possible to prevent a pest control fluid injected from the nozzles of the booms 4 from being sprayed to a crop plant etc. in a repeated manner and it is possible to spray a pest control fluid evenly.

According to the embodiment described above, the following effects can be obtained.

The boom vibration control device 9 includes the first accumulator portion 51 (the left-roll-direction biasing unit) that biases the booms 4 in the left roll direction with respective to the working vehicle 90 and the second accumulator portion 61 (the right-roll-direction biasing unit) that biases the booms 4 in the right roll direction with respective to the working vehicle 90. With such a configuration, because the force to roll the booms 4 in the roll direction can be generated by the difference between the gas pressure (the biasing force) of the first accumulator portion 51 biasing the booms 4 in the left roll direction and the gas pressure (the biasing force) of the second accumulator portion 61 biasing the booms 4 in the right roll direction, it is possible to keep the roll angle of the booms 4 at the position where both gas pressures are balanced.

Furthermore, when the working vehicle 90 runs over a rough surface and the posture of the working vehicle 90 is changed in the roll direction, the fluid pressure cylinder 30 extends and contracts by the inertial force that holds the booms 4 at the same position. By doing so, the change in the force acting on the roll mount 5 from the working vehicle 90 is moderated, and it is possible to suppress the excessively large roll of the booms 4 in the roll direction. Therefore, it is possible to prevent the tip-end portions 4B of the booms 4 from hitting a field etc.

Furthermore, the boom vibration control device 9 includes the fluid pressure cylinder 30 that is extended and contracted in an interlocked manner with the roll of the booms 4 in the left and right roll directions. The fluid pressure cylinder 30 includes the cylinder tube 31 that is linked to the one of the raising and lowering mount 3 and the booms 4 of the working vehicle 90 and that is filled with the hydraulic fluid, the piston rod 32 that is linked to the other of the raising and lowering mount 3 and the booms 4 of the working vehicle 90 and that is inserted into the cylinder tube 31, and the piston 33 that is linked to the piston rod 32 and that partitions the inside of the cylinder tube 31 into the head-side chamber 35 and the bottom-side chamber 34. The boom vibration control device 9 includes the first accumulator portion 51, serving as the left-roll-direction biasing unit, that stores the compressed gas and pressurizes the head-side chamber 35 and the second accumulator portion 61, serving as the right-roll-direction biasing unit, that stores the compressed gas and pressurizes the bottom-side chamber 34. With such a configuration, the boom vibration control device 9 can bias the booms 4 in the right roll direction and the left roll direction by using one fluid pressure cylinder 30, thereby enabling simplification of the configuration.

Furthermore, the boom vibration control device 9 includes the accumulators 50 and 60 having the accumulator portions 51 and 61 and the damping valves 53 and 63 (throttles) that provide resistance on the hydraulic oil flowing in and out of the accumulators 50 and 60 with the extension and contraction of the fluid pressure cylinder 30. With such a configuration, because the damping force is generated by the resistance provided on the flow of the hydraulic oil by the damping valves 53 and 63, it is possible to suppress the vibration of the booms 4 in the roll direction.

Furthermore, the hydraulic-fluid supply and discharge device 70 constitutes the roll-angle adjusting mechanism that adjusts the roll angle of the booms 4 by rolling the booms 4 in the roll direction by supplying/discharging the hydraulic oil to/from the fluid pressure cylinder 30. With such a configuration, the fluid pressure cylinder 30 functions as a damper that suppresses the vibration of the booms 4 in the roll direction and, at the same time, functions as an actuator that adjusts the set roll angle of the booms 4 in accordance with the inclination etc. in a field, and therefore, it is possible to simplify the configuration of the boom vibration control device 9.

Next, the second embodiment will be described.

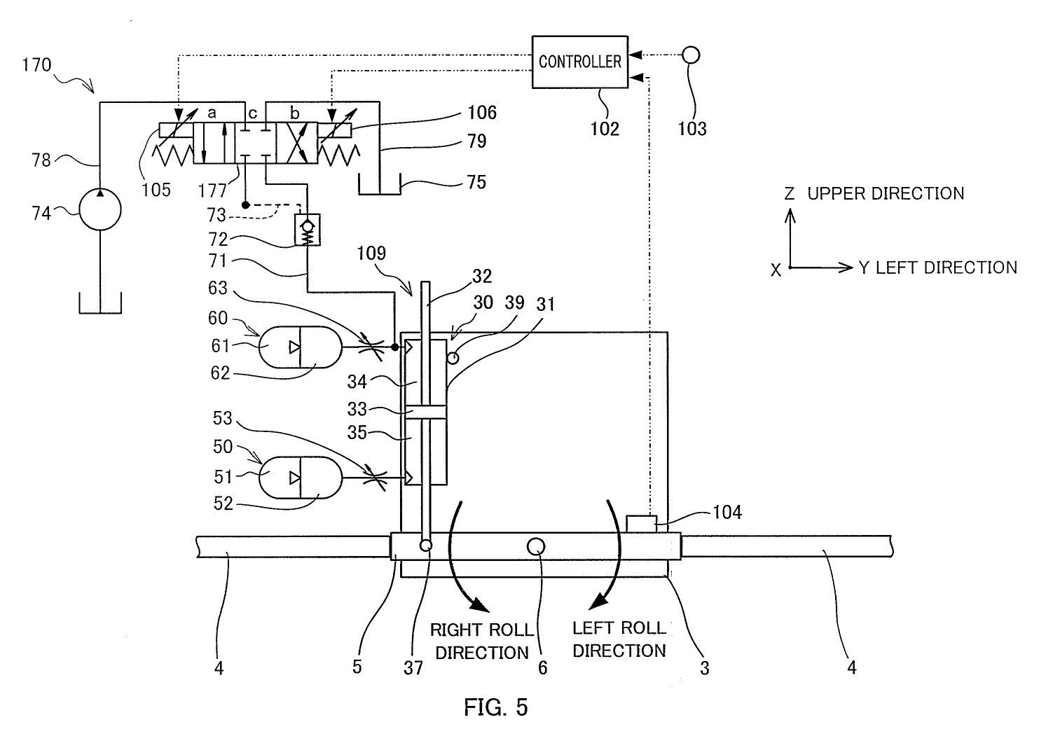

FIG. 5 is a schematic configuration diagram of a boom vibration control device 109 in this embodiment. In the following description, differences from the first embodiment will be mainly described, while structures that are identical to those in the boom sprayer 1 in the first embodiment are assigned the same reference signs, and a description thereof is omitted.

While the hydraulic-fluid supply and discharge device 70 in the first embodiment includes the manually-switched direction selector valve 77, a hydraulic-fluid supply and discharge device 170 in this embodiment includes an electromagnetically-switched direction selector valve 177.

The boom vibration control device 109 includes a roll angle detector 104 that detects the roll angle of the booms 4 relative to the horizontal line, a set-roll-angle command unit 103 that gives a command for the set roll angle of the booms 4, and a controller 102 that controls the operation of the direction selector valve 177.

When a driver operates the set-roll-angle command unit 103, a command signal for the set roll angle of the booms 4 is sent from the set-roll-angle command unit 103 to the controller 102. The controller 102 performs switching control of the position of the direction selector valve 177 by receiving the signal sent out from the roll angle detector 104 and the set-roll-angle command unit 103 and outputs a driving current to solenoids 105 and 106 of the direction selector valve 177, such that the detected roll angle of the booms 4 approaches the commanded set roll angle. In the case where the posture of the booms 4 is changed in the roll direction with the change in the posture of the working vehicle 90, the controller 102 switches the direction selector valve 177 in accordance with the signal from the roll angle detector 104 and adjusts the amount of hydraulic oil to be supplied/discharged to/from the fluid pressure cylinder 30. By doing so, the roll angle of the booms 4 is kept close to the commanded set roll angle.

Similarly to the first embodiment, the boom vibration control device 109 functions as a damper that suppresses the vibration of the booms 4 in the roll direction. For example, when the working vehicle 90 runs over a rough surface in a field and the posture of the working vehicle 90 is changed in the roll direction, as described above, it is possible to suppress the vibration of the booms 4 in the roll direction by the operation of the first accumulator 50 and the second accumulator 60.

According to the embodiment described above, the following effects can be obtained.

The boom vibration control device 109 includes the roll angle detector 104 that detects the roll angle of the booms 4 and the controller 102 that performs control such that the roll angle of the booms 4 matches the set roll angle by adjusting the amount of hydraulic oil to be supplied/discharged to/from the fluid pressure cylinder 30 in accordance with the detected roll angle of the booms 4. With such a configuration, it is possible to perform an automatic adjustment such that the roll angle of the booms 4 becomes equal to the commanded set roll angle.

Next, the third embodiment will be described.

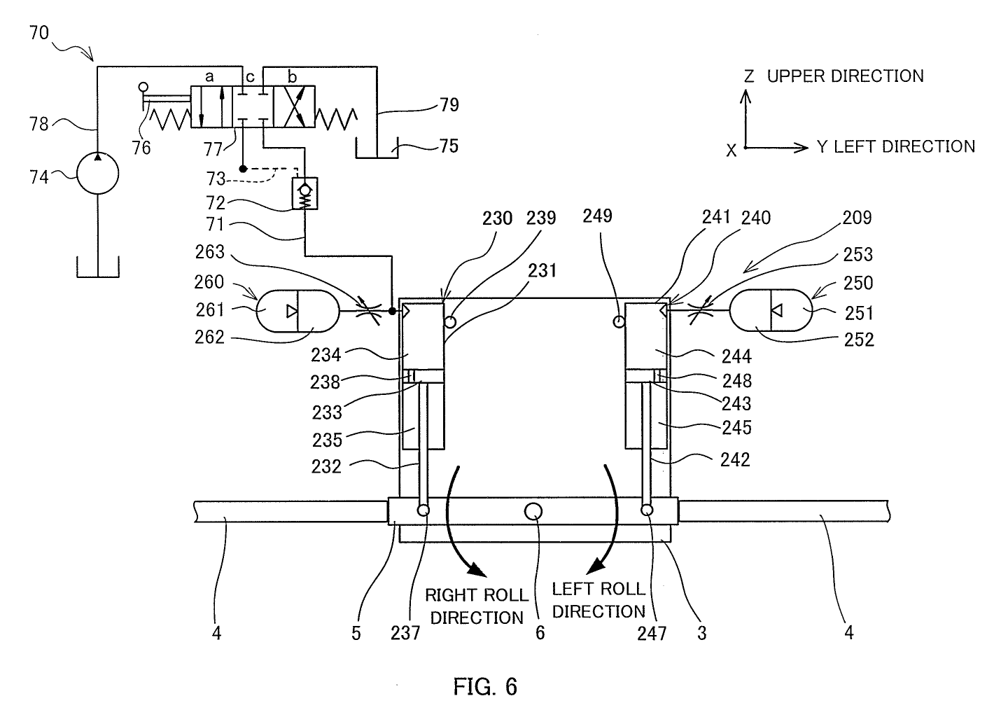

FIG. 6 is a schematic configuration diagram of a boom vibration control device 209 in this embodiment. In the following description, differences from the first embodiment will be mainly described, while structures that are identical to those in the boom sprayer 1 in the first embodiment are assigned the same reference signs, and a description thereof is omitted.

While the boom vibration control device 9 in the first embodiment biases the booms 4 in the left and right roll directions by using single fluid pressure cylinder 30, the boom vibration control device 209 in this embodiment biases the booms 4 in the left and right roll directions by using two fluid pressure cylinders 240 and 230.

The first fluid pressure cylinder 240 includes a first cylinder tube 241 filled with the hydraulic oil and a first piston rod 242 that is slidably inserted into the first cylinder tube 241. The first cylinder tube 241 is rotatably linked to the raising and lowering mount 3 via a spherical bearing 249. The tip-end portion of the first piston rod 242 is rotatably linked to the roll mount 5 via a spherical bearing 247. In other words, the first cylinder tube 241 is linked to the working vehicle 90 via the raising and lowering mount 3, and the first piston rod 242 is linked to the booms 4 via the roll mount 5. With such a configuration, the first fluid pressure cylinder 240 is extended and contracted in an interlocked manner with the roll of the booms 4 in the roll direction.

The configuration is not limited to that mentioned above, and it is possible to employ a configuration in which the first piston rod 242 is linked to the working vehicle 90 via the raising and lowering mount 3 and the first cylinder tube 241 is linked to the booms 4 via the roll mount 5.

The base-end portion of the first piston rod 242 includes a piston 243. The inside of the first cylinder tube 241 is partitioned into a head-side chamber 245 and a bottom-side chamber 244 by the piston 243.

A flow channel 248 is formed in the piston 243 for allowing the flow of the hydraulic oil between the head-side chamber 245 and the bottom-side chamber 244. The first fluid pressure cylinder 240 is a single-acting fluid pressure cylinder that is extended and contracted in response to the supply and discharge of the hydraulic oil to/from the bottom-side chamber 244 and the head-side chamber 245 in the first cylinder tube 241.

A first accumulator 250 is connected to the bottom-side chamber 244. The first accumulator 250 includes an oil chamber 252 that is in communication with the bottom-side chamber 244 and a first accumulator portion 251 that stores the compressed gas for pressurizing the oil chamber 252. The first accumulator portion 251 constitutes the left-roll-direction biasing unit that biases the booms 4 in the left roll direction by pressurizing the bottom-side chamber 244 and the head-side chamber 245. As the booms 4 roll in the roll direction, the hydraulic oil in the bottom-side chamber 244 flows into and out of the first accumulator 250, and the first accumulator portion 251 is expanded and contracted.

The configuration is not limited to that mentioned above, and it is possible to employ a configuration in which a bottom-side gas chamber that is filled with the compressed gas is defined via a free piston in the first cylinder tube 241, and the booms 4 are biased in the left roll direction by pressurizing the bottom-side chamber 244 by the gas pressure in the bottom-side gas chamber.

A damping valve 253, serving as a throttle, is interposed at a channel communicating the oil chamber 252 of the first accumulator 250 and the bottom-side chamber 244 of the first fluid pressure cylinder 240. The damping valve 253 provides resistance on the flow of the hydraulic oil flowing between the bottom-side chamber 244 and the oil chamber 252 with the extension and contraction of the first fluid pressure cylinder 240. By doing so, a damping force suppressing the vibration of the booms 4 in the roll direction is generated.

The second fluid pressure cylinder 230 includes a second cylinder tube 231 filled with the hydraulic oil and a second piston rod 232 that is slidably inserted into the second cylinder tube 231. The second cylinder tube 231 is rotatably linked to the raising and lowering mount 3 via a spherical bearing 239. The tip-end portion of the second piston rod 232 is rotatably linked to the roll mount 5 via a spherical bearing 237. In other words, the second cylinder tube 231 is linked to the working vehicle 90 via the raising and lowering mount 3, and the second piston rod 232 is linked to the booms 4 via the roll mount 5. With such a configuration, the second fluid pressure cylinder 230 is extended and contracted in an interlocked manner with the roll of the booms 4 in the roll direction.

The configuration is not limited to that mentioned above, and it is possible to employ a configuration in which the second piston rod 232 is linked to the working vehicle 90 via the raising and lowering mount 3 and the second cylinder tube 231 is linked to the booms 4 via the roll mount 5.

The base-end portion of the second piston rod 232 includes a piston 233. The inside of the second cylinder tube 231 is partitioned into a head-side chamber 235 and a bottom-side chamber 234 by the piston 233.

A flow channel 238 is formed in the piston 233 for allowing the flow of the hydraulic oil between the head-side chamber 235 and the bottom-side chamber 234. The second fluid pressure cylinder 230 is a single-acting fluid pressure cylinder that is extended and contracted in response to the supply and discharge of the hydraulic oil to/from the bottom-side chamber 234 and the head-side chamber 235 in the second cylinder tube 231.

A second accumulator 260 is connected to the bottom-side chamber 234. The second accumulator 260 includes an oil chamber 262 that is in communication with the bottom-side chamber 234 and a second accumulator portion 261 that stores the compressed gas for pressurizing the oil chamber 262. The second accumulator portion 261 constitutes the right-roll-direction biasing unit that biases the booms 4 in the right roll direction by pressurizing the bottom-side chamber 234 and the head-side chamber 235. As the booms 4 rolls in the roll direction, the hydraulic oil in the bottom-side chamber 234 flows into and out of the second accumulator 260, and the second accumulator portion 261 is expanded and contracted.

The configuration is not limited to that mentioned above, and it is possible to employ a configuration in which a bottom-side gas chamber that is filled with the compressed gas is defined via a free piston in the second cylinder tube 231, and the booms 4 are biased in the right roll direction by pressurizing the bottom-side chamber 234 by the gas pressure in the bottom-side gas chamber.

A damping valve 263, serving as a throttle, is interposed at a channel communicating the oil chamber 262 of the second accumulator 260 and the bottom-side chamber 234 of the second fluid pressure cylinder 230. The damping valve 263 provides resistance on the flow of the hydraulic oil flowing between the head-side chamber 235 and the oil chamber 262 with the extension and contraction of the second fluid pressure cylinder 230. By doing so, a damping force suppressing the vibration of the booms 4 in the roll direction is generated.

When the booms 4 are rolled in the left roll direction, the hydraulic oil in the first accumulator 250 flows into the extending first fluid pressure cylinder 240, and the hydraulic oil in the contracting second fluid pressure cylinder 230 flows into the second accumulator 260. Conversely, when the booms 4 are rolled in the right roll direction, the hydraulic oil in the second accumulator 260 flows into the extending second fluid pressure cylinder 230, and the hydraulic oil in the contracting first fluid pressure cylinder 240 flows into the first accumulator 250.

As described above, because the same amount of the hydraulic oil is supplied/discharged to/from the first accumulator 250 and the second accumulator 260 with the roll of the booms 4 in the left and right roll directions, a gas pressure difference is generated between the first accumulator 250 and the second accumulator 260. The booms 4 are rolled to the position where the biasing force biasing the booms 4 in the left roll direction by the gas pressure of the first accumulator 250 and the biasing force biasing the booms 4 in the right roll direction by the gas pressure of the second accumulator 260 are balanced and are held at the set roll angle.

The hydraulic-fluid supply and discharge device 70 supplies/discharges the hydraulic oil to/from the bottom-side chamber 234 of the second fluid pressure cylinder 230 to cause the booms 4 roll in the roll direction. It is possible to employ a configuration in which the hydraulic-fluid supply and discharge device 70 supplies/discharges the hydraulic oil to/from the head-side chamber 235 to cause the booms 4 roll in the roll direction.

In addition, it is possible to employ a configuration in which the hydraulic-fluid supply and discharge device 70 supplies/discharges the hydraulic oil to/from the second fluid pressure cylinder 230 and the first fluid pressure cylinder 240. In this case, it is preferred to perform the control such that the amount of hydraulic oil supplied/discharged to/from the second fluid pressure cylinder 230 is equalized to the amount of hydraulic oil supplied/discharged to/from the first fluid pressure cylinder 240.

In the case where the posture of the working vehicle 90 is changed in the roll direction when a boom sprayer is operated, the force that causes the booms 4 to roll in the roll direction acts on the roll mount 5 via the first fluid pressure cylinder 240 and the second fluid pressure cylinder 230. Because the booms 4 tend to stay at the same position due to the inertial force, the first fluid pressure cylinder 240 and the second fluid pressure cylinder 230 extend and contract to absorb the tilt of the working vehicle 90. Although the rolling vibration of the booms 4 begins if the first fluid pressure cylinder 240 and the second fluid pressure cylinder 230 cannot absorb the tilt of the working vehicle 90 completely and the force by the gas pressure difference between the first accumulator portion 251 and the second accumulator portion 261 exceeds the inertial force of the booms 4, the rolling vibration is damped rapidly by the damping valves 253 and 263.

As described above, because the change in the force acting on the roll mount 5 is moderated by the extension and contraction of the first fluid pressure cylinder 240 and the second fluid pressure cylinder 230, it is possible to suppress the excessively large roll of the booms 4 in the roll direction and to prevent the tip-end portions 4B of the booms 4 from hitting a field etc.

Furthermore, because the damping valves 253 and 263 provide resistance on the flow of the hydraulic oil flowing in and out of the first accumulator 250 and the second accumulator 260 with the extension and contraction of the first fluid pressure cylinder 240 and the second fluid pressure cylinder 230, it is possible to suppress the vibration of the booms 4 in the roll direction. By doing so, it is possible to prevent a pest control fluid injected from the nozzles of the booms 4 from being sprayed to a crop plant etc. in a repeated manner and it is possible to spray a pest control fluid evenly.

According to the embodiment described above, the following effects can be obtained.

The boom vibration control device 209 includes the first fluid pressure cylinder 240 and the second fluid pressure cylinder 230 that are extended and contracted in an interlocked manner with the roll of the booms 4 in the left and right roll directions. The first fluid pressure cylinder 240 includes the first cylinder tube 241 that is linked to the booms 4 and that is filled with the hydraulic fluid and the first piston rod 242 that is linked to the working vehicle 90 and that is inserted into the first cylinder tube 241. The boom vibration control device 209 includes the first accumulator portion 251, serving as the left-roll-direction biasing unit, that stores the compressed gas for pressurizing the inside of the first cylinder tube 241. The second fluid pressure cylinder 230 includes the second cylinder tube 231 that is linked to the booms 4 and that is filled with the hydraulic fluid and the second piston rod 232 that is linked to the working vehicle 90 and that is inserted into the second cylinder tube 231. The boom vibration control device 209 includes the second accumulator portion 261, serving as the right-roll-direction biasing unit, that stores the compressed gas for pressurizing the inside of the second cylinder tube 231.

With such a configuration, when the working vehicle 90 runs over a rough surface and the posture of the working vehicle 90 is changed in the roll direction, because the change in the force acting on the roll mount 5 from the working vehicle 90 is moderated by the extension and contraction of the first fluid pressure cylinder 240 and the second fluid pressure cylinder 230 due to the inertial force of the booms 4, it is possible to suppress the excessively large roll of the booms 4 in the roll direction. Therefore, it is possible to prevent the tip-end portions 4B of the booms 4 from hitting a field etc.

Next, the fourth embodiment will be described.

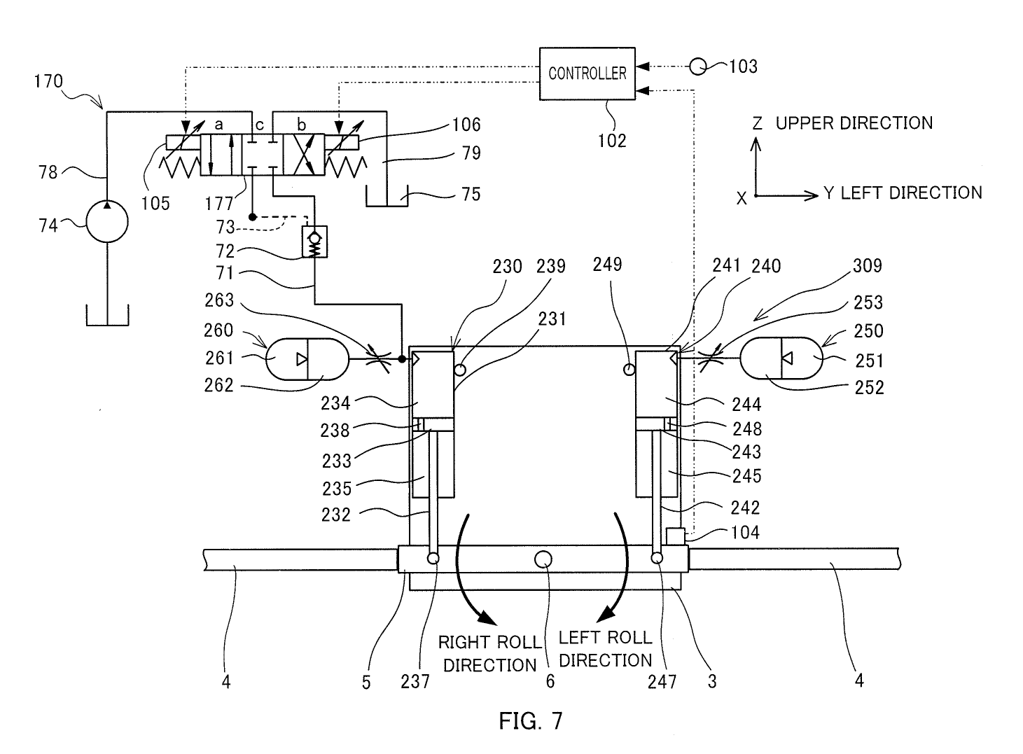

FIG. 7 is a schematic configuration diagram of a boom vibration control device 309 in this embodiment. In the following description, differences from the third embodiment will be mainly described, while structures that are identical to those in the boom vibration control device 109 in the second embodiment and the boom vibration control device 209 in the above-mentioned third embodiment are assigned the same reference signs, and a description thereof is omitted.

While the hydraulic-fluid supply and discharge device 70 in the third embodiment includes the manually-switched direction selector valve 77, the hydraulic-fluid supply and discharge device 170 in this embodiment includes an electromagnetically-switched direction selector valve 177.

The boom vibration control device 309 includes the roll angle detector 104 that detects the roll angle of the booms 4 relative to the horizontal line, the set-roll-angle command unit 103 that gives a command for the set roll angle of the booms 4, and the controller 102 that controls the operation of the direction selector valve 177.

When a driver operates the set-roll-angle command unit 103, a command signal for the set roll angle of the booms 4 is sent from the set-roll-angle command unit 103 to the controller 102. The controller 102 performs switching control of the position of the direction selector valve 177 by receiving the signal sent out from the roll angle detector 104 and the set-roll-angle command unit 103 and outputs a driving current to solenoids 105 and 106 of the direction selector valve 177, such that the detected roll angle of the booms 4 approaches the commanded set roll angle.

The hydraulic-fluid supply and discharge device 170 includes the controller 102 that controls the amount of hydraulic oil to be supplied/discharged to/from the second fluid pressure cylinder 230 in accordance with the detected roll angle of the booms 4, and the hydraulic-fluid supply and discharge device 170 constitutes the roll-angle adjusting mechanism that automatically adjusts the roll angle of the booms 4 by rolling the booms 4 in the roll direction. In the case where the posture of the booms 4 is changed in the roll direction with the change in the posture of the working vehicle 90, the controller 102 switches the position of the direction selector valve 177 in accordance with the signal from the roll angle detector 104. By doing so, the roll angle of the booms 4 is automatically adjusted to the commanded set roll angle.

Similarly to the third embodiment, the boom vibration control device 309 functions as a damper that suppresses the vibration of the booms 4 in the roll direction. For example, when the working vehicle 90 runs over a rough surface in a field and the posture of the working vehicle 90 is changed in the roll direction, because the change in the force acting on the roll mount 5 from the working vehicle 90 is moderated by the extension and contraction of the first fluid pressure cylinder 240 and the second fluid pressure cylinder 230 due to the inertial force of the booms 4, it is possible to suppress the excessively large roll of the booms 4 in the roll direction. Therefore, it is possible to prevent the tip-end portions 4B of the booms 4 from hitting a field etc.

Because the vibration of the booms 4 in the roll direction can be suppressed, the boom sprayer 1 for spraying a pest control fluid that includes the boom vibration control device 9, 109, 209, or 309 in any of the first to fourth embodiments is capable of spraying a pest control fluid evenly from the booms 4 and improving the operation speed.

The embodiments of the present invention described above are merely illustration of some application examples of the present invention and not of the nature to limit the technical scope of the present invention to the specific constructions of the above embodiments.

For example, the left-roll-direction biasing unit and the right-roll-direction biasing unit are not limited to those using the compressed gas, and, for example, metal springs etc. may also be used.

Furthermore, the booms 4 are not limited to those extending to left and right from the working vehicle 90, and that extending to either left or right from the working vehicle 90 may also be used.

The present application claims a priority based on Japanese Patent Application No. 2013-003993 filed with the Japan Patent Office on Jan. 11, 2013, all the contents of which are hereby incorporated by reference.

What is claimed is:

1. A boom vibration control device that is configured to suppress vibration of a boom that is cantilever-supported on a working vehicle, comprising:
a left-roll-direction biasing unit that biases the boom in a left roll direction with respective to the working vehicle; and
a right-roll-direction biasing unit that biases the boom in a right roll direction with respective to the working vehicle, wherein
the boom is held at a roll angle at which a biasing force of the left-roll-direction biasing unit and a biasing force of the right-roll-direction biasing unit are balanced.

2. A boom vibration control device according to claim 1, further comprising:
a fluid pressure cylinder that is extended and contracted in an interlocked manner with the roll of the boom in the left and right roll directions; and
a accumulator portion that stores a compressed gas for pressurizing the fluid pressure cylinder, wherein
the fluid pressure cylinder includes a cylinder tube that is linked to the one of the working vehicle and the boom and that is filled with a hydraulic fluid, a piston rod that is linked to the other of the working vehicle and the boom and that is inserted into the cylinder tube, and a piston that is linked to the piston rod to partition the inside of the cylinder tube into a head-side chamber and a bottom-side chamber,
the accumulator portion includes the first accumulator portion that stores a compressed gas for pressurizing the one of the head-side chamber and the bottom-side chamber and the second accumulator portion that stores a compressed gas for pressurizing the other of the head-side chamber and the bottom-side chamber, and
the left-roll-direction biasing unit is the first accumulator portion and the right-roll-direction biasing unit is the second accumulator portion.

3. A boom vibration control device according to claim 2, further comprising:
an accumulator that has the accumulator portion; and
a throttle that provides resistance on a hydraulic fluid flowing into and out of the accumulator with extension and contraction of the fluid pressure cylinder.

4. A boom vibration control device according to claim 2, further comprising:
a roll-angle adjusting mechanism that adjusts a roll angle of the boom by rolling the boom in the left and right roll directions by supplying/discharging a hydraulic fluid to/from the fluid pressure cylinder.

5. A boom vibration control device according to claim 4, further comprising:
a roll angle detector that detects the roll angle of the boom; and
a controller that performs a control such that the roll angle of the boom becomes equal to a set roll angle by adjusting amount of a hydraulic fluid that is to be supplied/discharged to/from the fluid pressure cylinder in accordance with the detected roll angle of the boom.

6. A boom vibration control device according to claim 1, further comprising:
a fluid pressure cylinder that is extended and contracted in an interlocked manner with the roll of the boom in the left and right roll directions; and
a accumulator portion that stores a compressed gas for pressurizing the fluid pressure cylinder, wherein
the fluid pressure cylinder includes a first fluid pressure cylinder and a second fluid pressure cylinder,
the first fluid pressure cylinder includes a first cylinder tube that is linked to the one of the working vehicle and the boom and that is filled with a hydraulic fluid and a first piston rod that is linked to the other of the working vehicle and the boom and that is inserted into the first cylinder tube,
the second fluid pressure cylinder includes a second cylinder tube that is linked to the one of the working vehicle and the boom and that is filled with a hydraulic fluid and a second piston rod that is linked to the other of the working vehicle and the boom and that is inserted into the second cylinder tube,
the accumulator portion includes a first accumulator portion that stores a compressed gas for pressurizing inside of the first cylinder tube and a second accumulator portion that stores a compressed gas for pressurizing inside of the second cylinder tube, and
the left-roll-direction biasing unit is the first accumulator portion and the right-roll-direction biasing unit is the second accumulator portion.

7. A boom vibration control device according to claim 6, further comprising:
an accumulator that has the accumulator portion; and
a throttle that provides resistance on a hydraulic fluid flowing into and out of the accumulator with extension and contraction of the fluid pressure cylinder.

8. A boom vibration control device according to claim 6, further comprising:
a roll-angle adjusting mechanism that adjusts a roll angle of the boom by rolling the boom in the left and right roll directions by supplying/discharging a hydraulic fluid to/from the fluid pressure cylinder.

9. A boom vibration control device according to claim 8, further comprising:
a roll angle detector that detects the roll angle of the boom; and
a controller that performs a control such that the roll angle of the boom becomes equal to a set roll angle by adjusting amount of a hydraulic fluid that is to be supplied/discharged to/from the fluid pressure cylinder in accordance with the detected roll angle of the boom.

10. A boom sprayer that is configured to spray a pest control fluid, comprising a boom vibration control device according to claim 1.
